(19) United States
(12) Patent Application Publication
(10) Pub. No.: US 2012/0305679 A1
(43) Pub. Date: Dec. 6, 2012

(54) Hydrajetting nozzle and method

(75) Inventors: Jim SURJAATMADJA, Duncan, OK (US); Billy W. McDANIEL, Duncan, OK (US); Philippe QUERO, Pointe Noire (CG)

(73) Assignee: Halliburton Energy Services, Inc., Houston, TX (US)

(21) Appl. No.: 13/151,074

(22) Filed: Jun. 1, 2011

(51) Int. Cl. A62C 31/02

(52) U.S. Cl. 239/589

(57) ABSTRACT

A jetting tool has a nozzle with a coefficient of discharge greater than 1.0. The jetting tool has a length and a diameter of an expansion section of the nozzle configured such that a fluid stream diameter of a fluid stream discharged from the nozzle is equal to the diameter of the expansion section at an outer end of the nozzle.

### CROSS-REFERENCE TO RELATED APPLICATIONS

Not applicable.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Hydrocarbon-producing wells often are stimulated by hydraulic fracturing operations, wherein a fracturing fluid may be introduced into a portion of a subterranean formation penetrated by a wellbore at a hydraulic pressure sufficient to create or enhance at least one fracture therein. Stimulating or treating the wellbore in such ways increases hydrocarbon production from the well. The fracturing equipment may be included in a service assembly used in the overall production process.

In some hydraulic fracturing operations, the fracturing fluid enters the subterranean formation through one or more openings or bores. The openings may be formed using a variety of techniques including jetting, perforating using explosive charges, and using casing valves. Jetting requires that a fluid pass through a nozzle at high pressure, where the fluid is generally supplied through the use of pumps or other pressurization equipment at the surface of the wellbore. The use of numerous openings may require large volumetric flow rates of fluids at high pressure to form the appropriate openings. These high flow rates can result in a large pressure drop due to friction and other internal fluid forces, which is compounded by the increasing flow path lengths associated with wells being drilled to increasing depths. The maximum operating pressures of the pumping equipment therefore limit the flow rates and number of openings that can be formed using jetting in the subterranean formation.

### SUMMARY

Disclosed herein is a jetting tool comprising a nozzle with a coefficient of discharge greater than 1.0. The jetting tool may have a length and a diameter of an expansion section of the nozzle configured such that a fluid stream diameter of a fluid stream discharged from the nozzle is equal to the diameter of the expansion section at an outer end of the nozzle. The nozzle may have a pressure drop within the expansion section of greater than about 10% as compared to the pressure at an outer edge of a comparative nozzle not having an expansion section. In addition, the nozzle may have an increased flowrate of fluid through the nozzle of greater than about 10% as compared to a comparative nozzle not comprising an expansion section.

Further disclosed herein is a jetting nozzle comprising a body, and an interior flow path within the body. The interior flow path comprises a flow section; and an expansion section. The expansion section has a diameter 1.01 to 1.5 times greater than a diameter of the flow section. A length and diameter of the expansion section are configured to prevent a backflow of fluid into the expansion section when a fluid is flowing through the nozzle. The body may be constructed of an abrasion resistant material, an erosion resistant material, or an abrasion and erosion resistant material. The interior flow path may also have an inlet section. A length of the flow section may be greater than about three times the diameter of the flow section. The length of the expansion section may be between about one half of the diameter of the flow section and about four times the diameter of the flow section. The expansion section may comprise a chamber between a fluid flowing through the jetting nozzle and the inner edge of the expansion section, and the chamber may have a reduced pressure relative to a pressure of an ambient fluid outside of the nozzle. The nozzle may have a coefficient of discharge of greater than 1.0.

Still further disclosed herein is a method of jetting comprising: providing a pressurized fluid to a nozzle; and allowing the pressurized fluid to flow through the nozzle, wherein the nozzle has a coefficient of discharge of greater than 1.0. The nozzle may be part of a service tool servicing a wellbore disposed in a subterranean formation, and the pressurized fluid may comprise an abrasive wellbore servicing fluid. The method may also include forming a fluid jet at the outlet of the nozzle, where the fluid jet may have a velocity of from about 300 feet per second to about 2000 feet per second or higher. The fluid jet may have a velocity of from about 50 feet per second to about 2700 feet per second or higher. The method may also include forming an eroded slot or a perforation tunnel in the subterranean formation with the fluid jet. The method may also include introducing the same fluid and/or a second pressurized fluid into the subterranean formation at a pressure sufficient to form one or more fractures in fluid communication with the slot or the perforation tunnel. The method may also include allowing one or more hydrocarbons to flow from the one or more fractures through the slot or the perforation tunnels and into the wellbore.

### BRIEF DESCRIPTION OF THE DRAWINGS

For a more complete understanding of the present disclosure and the advantages thereof, reference is now made to the following brief description, taken in connection with the accompanying drawings and detailed description:

FIG. 1A is a simplified cross-sectional view of an embodiment of a wellbore servicing apparatus in an operating environment.

FIG. 1B is a simplified cross-sectional view of an embodiment of a wellbore servicing apparatus in a wellbore.

FIG. 2 is a cross-sectional view of an embodiment of a nozzle.

FIG. 3 is a schematic flow diagram of an embodiment of a fluid flow through a nozzle.

### DETAILED DESCRIPTION OF THE EMBODIMENTS

In the drawings and description that follow, like parts are typically marked throughout the specification and drawings with the same reference numerals, respectively. The drawing figures are not necessarily to scale. Certain features of the invention may be shown exaggerated in scale or in somewhat schematic form and some details of conventional elements may not be shown in the interest of clarity and conciseness. Specific embodiments are described in detail and are shown in the drawings, with the understanding that the present disclosure is to be considered an exemplification of the principles of the invention, and is not intended to limit the invention to that illustrated and described herein. It is to be fully recognized that the different teachings of the embodiments discussed infra may be employed separately or in any suitable combination to produce desired results.

Unless otherwise specified, any use of any form of the terms “connect,” “engage,” “couple,” “attach,” or any other term describing an interaction between elements is not meant to limit the interaction to direct interaction between the elements and may also include indirect interaction between the elements described. In the following discussion and in the claims, the terms “including” and “comprising” are used in an open-ended fashion, and thus should be interpreted to mean “including, but not limited to . . . ”. Reference to up or down will be made for purposes of description with “up,” “upper,” “upward,” or “upstream” meaning toward the surface of the wellbore and with “down,” “lower,” “downward,” or “downstream” meaning toward the terminal end of the well, regardless of the wellbore orientation. The term “zone” or “pay zone” as used herein refers to separate parts of the wellbore designated for treatment or production and may refer to an entire hydrocarbon formation or separate portions of a single formation such as horizontally and/or vertically spaced portions of the same formation. As used herein, “service” or “servicing” refers to any operation or procedure used to drill, complete, work over, fracture, repair, or in any way prepare or restore a wellbore for the recovery of materials residing in a subterranean formation penetrated by the wellbore. The various characteristics mentioned above, as well as other features and characteristics described in more detail below, will be readily apparent to those skilled in the art with the aid of this disclosure upon reading the following detailed description of the embodiments, and by referring to the accompanying drawings.

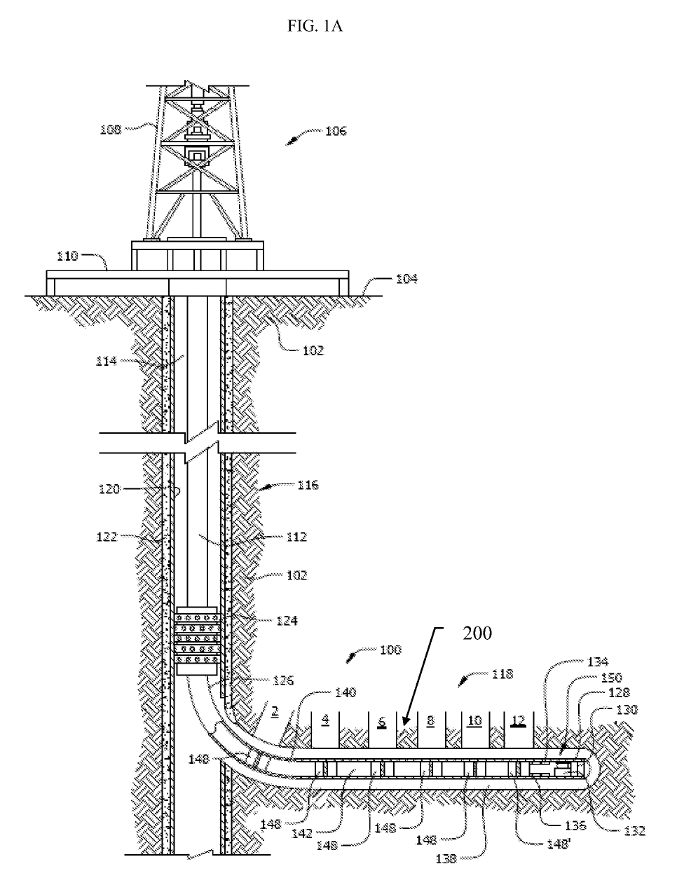

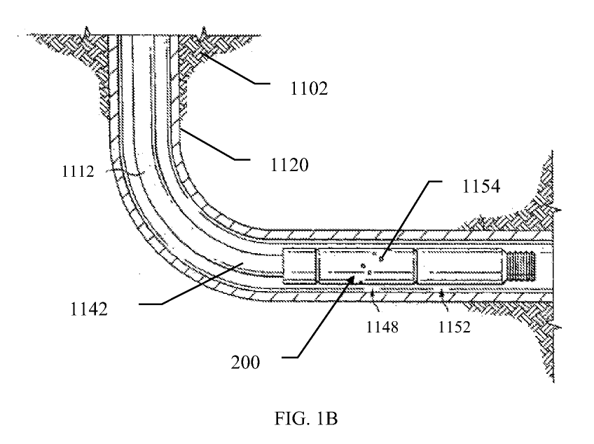

Referring now to FIG. 1A, an embodiment of a wellbore servicing apparatus 100 is shown in an operating environment. While the wellbore servicing apparatus 100 is shown and described with specificity, various other wellbore servicing apparatus embodiments consistent with the teachings herein are described infra. The wellbore servicing apparatus 100 comprises a drilling rig 106 that is positioned on the earth's surface 104 and extends over and around a wellbore 114 that penetrates a subterranean formation 102 for the purpose of recovering hydrocarbons. The wellbore 114 may be drilled into the subterranean formation 102 using any suitable drilling technique. The wellbore 114 extends substantially vertically away from the earth's surface 104 over a vertical wellbore portion 116, and in some embodiments may deviate at one or more angles from the earth's surface 104 over a deviated or horizontal wellbore portion 118. In alternative operating environments, all or portions of the wellbore may be vertical, deviated at any suitable angle, horizontal, and/or curved, and may comprise multiple laterals extending at various angles from a primary, vertical wellbore.

At least a portion of the vertical wellbore portion 116 may be lined with a casing 120 that is secured into position against the subterranean formation 102 in a conventional manner using cement 122. In alternative operating environments, the horizontal wellbore portion 118 may be cased and cemented and/or portions of the wellbore may be uncased (e.g., an open hole completion). The drilling rig 106 comprises a derrick 108 with a rig floor 110 through which a tubing or work string 112 (e.g., cable, wireline, E-line, Z-line, jointed pipe, coiled tubing, casing, or liner string, etc.) extends downward from the drilling rig 106 into the wellbore 114. The work string 112 delivers the wellbore servicing apparatus 100 to a predetermined depth within the wellbore 114 to perform an operation such as perforating the casing 120 and/or subterranean formation 102, creating a fluid path from the flow passage 142 to the subterranean formation 102, creating (e.g., initiating and/or extending) slots, perforation tunnels, and/or fractures (e.g., dominant/primary fractures, micro-fractures, etc.) within the subterranean formation 102, producing hydrocarbons from the subterranean formation 102 through the wellbore (e.g., via a production tubing or string), or other completion operations. The drilling rig 106 comprises a motor driven winch and other associated equipment for extending the work string 112 into the wellbore 114 to position the wellbore servicing apparatus 100 at the desired depth.

While the operating environment depicted in FIG. 1A refers to a stationary drilling rig 106 for lowering and setting the wellbore servicing apparatus 100 within a land-based wellbore 114, one of ordinary skill in the art will readily appreciate that mobile workover rigs, wellbore servicing units (such as coiled tubing units), and the like may be used to lower the wellbore servicing apparatus 100 into the wellbore 114. It should be understood that the wellbore servicing apparatus 100 may alternatively be used in other operational environments, such as within an offshore wellbore operational environment.

FIG. 1A illustrates a wellbore servicing apparatus 100 that may be used during production of the wellbore. As a result, the wellbore servicing apparatus 100 may remain in the well for extended periods of time while being removable for various servicing procedures as needed. The wellbore servicing apparatus 100 may comprise an upper end comprising a liner hanger 124 (such as a Halliburton VersaFlex® liner hanger), a lower end 128, and a tubing section 126 extending therebetween. The tubing section 126 may comprise a toe assembly 150 for selectively allowing fluid passage between flow passage 142 and annulus 138. The toe assembly 150 may comprise a float shoe 130, a float collar 132, a tubing conveyed device 134, and a polished bore receptacle 136 housed near the lower end 128. The components of toe assembly 150 (float shoe 130, float collar 132, tubing conveyed device 134, and polished bore receptacle 136) may actuated by hydraulic shifting or mechanical shifting as necessary to allow fluid communication between flow passage 142 and annulus 138. In alternative embodiments, a tubing section may further comprise a plurality of packers that function to isolate formation zones (e.g., zones 2, 4, 6, 8, 10, 12) from each other along the tubing section. The plurality of packers may be any suitable packers such as swellpackers, inflatable packers, squeeze packers, production packers, or combinations thereof.

The horizontal wellbore portion 118 and the tubing section 126 define an annulus 138 therebetween. The tubing section 126 comprises an interior wall 140 that defines a flow passage 142 therethrough. In some embodiments, an inner string may be disposed in the flow passage 142 and the inner string may extend therethrough so that an inner string lower end connects to toe assembly 150. The float shoe 130, the float collar 132, the tubing conveyed devices 134, and the polished bore receptacle 136 of toe assembly 150 may be actuated by mechanical shifting techniques using the inner string as necessary to allow fluid communication between fluid passage 142 and annulus 138.

By way of a non-limiting example, six service assemblies 148 are connected and disposed in-line along the tubing section 126, and are housed in the flow passage 142 of the tubing section 126. Each of the formation zones 2, 4, 6, 8, 10, and 12 has a separate and distinct one of the six service assemblies 148 associated therewith. Each service assembly 148 can be independently selectively actuated to expose different formation zones 2, 4, 6, 8, 10, and/or 12 for servicing, stimulation, and/or production (e.g., flow of a wellbore servicing fluid from the flow passage 142 of the work string 112 to the formation and/or flow of a production fluid to the flow passage 142 of the work string 112 from the formation) at different times. In this embodiment, the service assemblies 148 are ball drop actuated. In alternative embodiments, the service assemblies may be mechanical shift actuated, mechanically actuated, hydraulically actuated, electrically actuated, coiled tubing actuated, wireline actuated, or combinations thereof to increase or decrease a fluid path between the interior of service assemblies and the associated formation zones (e.g., by opening and/or closing a window or sliding sleeve). In alternative embodiments, the service assemblies may be any suitable service assemblies.

In an embodiment, the service assemblies 148 may each comprise a housing with one or more nozzles 200 associated therewith. The service assemblies 148 may be configured to be directly connected to or threaded into a tubing section such as tubing section 126 (or in alternative embodiments of a wellbore servicing apparatus, to other service assemblies). In some embodiments, the service assemblies 148 may comprise suitable structures (e.g., windows and/or sliding sleeves) for selective actuation of the service assembly.

In another embodiment shown in FIG. 1B, an assembly for servicing a well is illustrated in the lower portion of a wellbore. This assembly may be used to service a wellbore and may be removed prior to production of one or more fluids from the well. This assembly may be used in any of the operating environments described with respect to FIG. 1A. In the embodiment shown in FIG. 1B, one end of the work string 1112 may be connected to one end of a tubular jet sub 1148. The jet sub 1148 may comprise a tubular housing that includes a longitudinal flow passage coupled to the flow passage 1142 extending through the length of the housing. The jet sub 1148 may have a plurality of openings 1154 machined through its wall that form nozzles as described in more detail below. Alternatively, a plurality of openings 1154 may be machined through the wall of the jet sub 1148 and may be adapted to receive one or more suitable nozzles as described in more detail below. The openings 1154 containing the nozzles may extend through the wall of the casing 1120 in one plane and can extend perpendicular to the axis of the casing 1120, at an acute angle to the axis of the casing 1120, and/or aligned with the axis.

The lower end of the jet sub 1148 may have one or more additional components coupled thereto. In an embodiment, a valve sub 1152 may be connected to the other end of the jet sub 1148 for use in controlling the flow of fluid through the work string 1112. The valve sub 1152 may normally be closed to cause flow of fluid to discharge from the jet sub 1148. The valve sub 1152 may be used to allow for emergency reverse circulation processes, such as during screenouts, equipment failures, etc. Additional suitable components may be coupled to the jet sub 1148 and/or the valve sub 1152 such as any other components that may be used in the wellbore servicing process including sensors, recorders, centralizers, and the like. In addition, it is understood that other conventional components, such as centering devices, blow out preventers, strippers, tubing valves, anchors, seals etc. can be associated with the work string 1112 of FIG. 1B.

An annulus is formed between the inner surface of the casing 1120 and the outer surfaces of the work string 1112 and the jet sub 1148 and the valve sub 1152. Several different types of fluids may be pumped through the flow passage 1142 and out to the formation through the subs and the annulus. In order to treat the formation, the casing 1120 in the interval of interest must be either pre-perforated or perforated using conventional means; or it could be hydrajetted with sand using the jet sub 1148. Optionally, inside the casing section wire screens could be installed and packed with gravel in a manner well known in the art. The jet sub 1148 comprising the nozzles may then be activated by passing a fluid through the interior flow passage 1142 of the work string 1112, as described in more detail below.

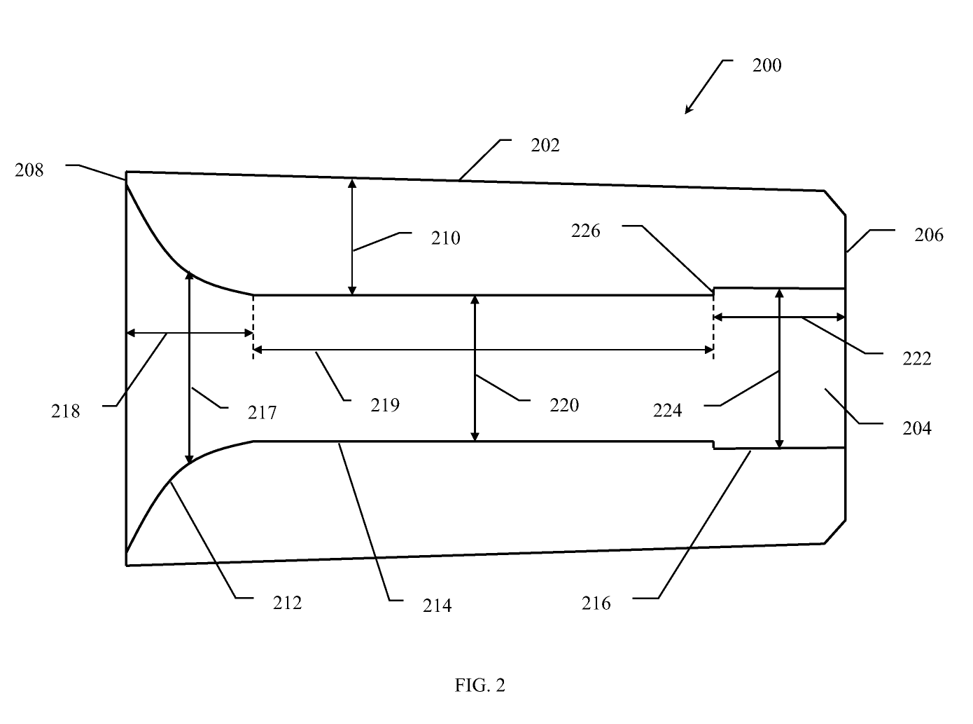

Irrespective of the type of work string, assembly, and/or tool in which the nozzle 200 of FIG. 2 is used, it will be appreciated that the nozzle 200 is configured to serve multiple functions. One function of the nozzle 200 is to increase the velocity of a fluid as it passes through the nozzle 200 to the formation. The nozzle 200 may be configured to restrict fluid flow and thus increase the fluid velocity (e.g., jetting the fluid) as the fluid passes through the nozzle 200. The jetted fluid may be jetted at a sufficient fluid velocity so that the jetted fluid can ablate and/or penetrate the lining (e.g., casing, cement, etc.) and/or the subterranean formation, thereby forming slots (e.g., eroded slots), perforation tunnels, micro-fractures, and/or extended fractures in the lining and/or subterranean formation. The jetted fluid may be flowed through the nozzle 200 for a jetting period to form a slot and/or perforation tunnel, micro-fractures, and/or extended fractures within the formation as described infra. Generally, the velocity of a jetted fluid is greater than 300 feet per second (ft/sec).

Referring to FIG. 2, the nozzle 200 is shown in greater detail. The nozzle 200 comprises a generally cylindrical body 202 defining an interior flowpath 204. The nozzle comprises an outer end 206 that faces the formation zone of interest and an inner end 208 that faces the flow passage 142. The outer diameter of the body 202 is configured to complement and be received and held within a port in the service assembly housing. The thickness 210 of body 202 may be adjusted depending on the need of the process and may be determined by one of ordinary skill in the art with the aid of this disclosure. The outer end 206 of the body may be beveled for ease of insertion into the port in the housing. In an embodiment, the diameter of the body 202 may narrow between the inner end 208 and the outer end 206 so that the body has an overall wedge or conical shape. This shape may aid in maintaining the nozzle 200 within the port in the housing and/or maintaining sealing engagement of the nozzle 200 in the port to prevent channeling of fluid around the nozzle 200 upon the application of pressure to the flow passage 142 (as shown in FIG. 1A).

The body 202 of the nozzle 200 may be constructed of any suitable materials. In an embodiment, the body 202 may be constructed of an abrasion and/or erosion resistant material. Suitable abrasion and/or erosion resistant materials may comprise matrix materials such as carbide particles in a metal matrix (e.g., tungsten carbide by itself or in a metallic binder, such as cobalt, tin, and/or nickel), ceramics, erosion resistant metals and alloys (e.g., tungsten carbide), and combinations thereof. In some embodiments, the nozzle 200 may only be needed for a limited time. In these embodiments, the body 202 may be constructed of a material that can be removed through degradation, abrasion, erosion, mechanical removal, etc. For example, the body 202 may be constructed of water soluble materials (e.g., water soluble aluminum, biodegradable polymer such as polylactic acid, etc.), acid soluble materials (e.g., aluminum, steel, etc.), thermally degradable materials (e.g., magnesium metal, thermoplastic materials, composite materials, etc.), or combinations thereof. The interior flowpath 204 is positioned within the body 202 to provide fluid communication between the flow passage 142 adjacent the inner end 208 and the formation adjacent the outer end 206. The interior flowpath 204 may be positioned concentrically within the body 202 and may be cylindrical in shape, however, in some embodiments, the shape of the interior flowpath may vary to some degree. The diameter of the interior flowpath 204 may be chosen to provide the desired fluid flow rate and fluid velocity at the appropriate operating conditions (e.g., pressure, temperature, etc.) and wellbore service fluid types (e.g., particulate type and/or concentration, fluid viscosity, fluid composition, etc.).

As shown in FIG. 2, the body 202 may be configured to provide several distinct flow portions of the interior flowpath 204. For example, the interior flowpath 204 may comprise an inlet section 212, a flow section 214, and an expansion section 216. Nozzle 200 may be integrally formed from a single body 202 portion, although it will be appreciated by one of ordinary skill in the art that the various sections of the nozzle 200 may be contained in separate components that are coupled together. Fluid flowing from the flow passage 142 may first flow through the inlet section 212, which is optional. The inlet section 212 may have a decreasing diameter 217 along its length 218 between the inner end 208 of the body 202 and the interface with the flow section 214. The diameter 217 may decrease gradually (e.g., over a curved surface) or may decrease in one or more steps, which may correspond to one or more sharp edges. In an embodiment, the diameter 220 of the flow section 214 may extend to the inner edge 208 of the nozzle 200, in which case the inlet section 212 may not be considered to be present. The flow section 214 may have a relatively uniform diameter 220 along its length 219. The diameter of the expansion section 216 is greater than the diameter 220 of the flow section 214 and may be relatively uniform along its length 222. The expansion section 216 extends to the outer edge 206 of the nozzle 200.

The diameter 220 of the flow section 214 is less than the diameter 224 of the expansion section 216, thereby creating a shoulder 226 at the intersection of the flow section 214 and the expansion section 216. The shoulder 226 may be formed as an edge disposed perpendicular to the central longitudinal axis of the interior flowpath 204. In an embodiment, the shoulder may be formed of a generally flat edge that may be tilted up to about 30 degrees from a plane perpendicular to the longitudinal axis of the interior flowpath 204. In an embodiment, the shoulder 226 may comprise one or more rounded edges or surfaces to allow the shoulder to extend from the diameter 220 of the flow section 214 to the diameter 224 of the expansion section 216 over a short distance.

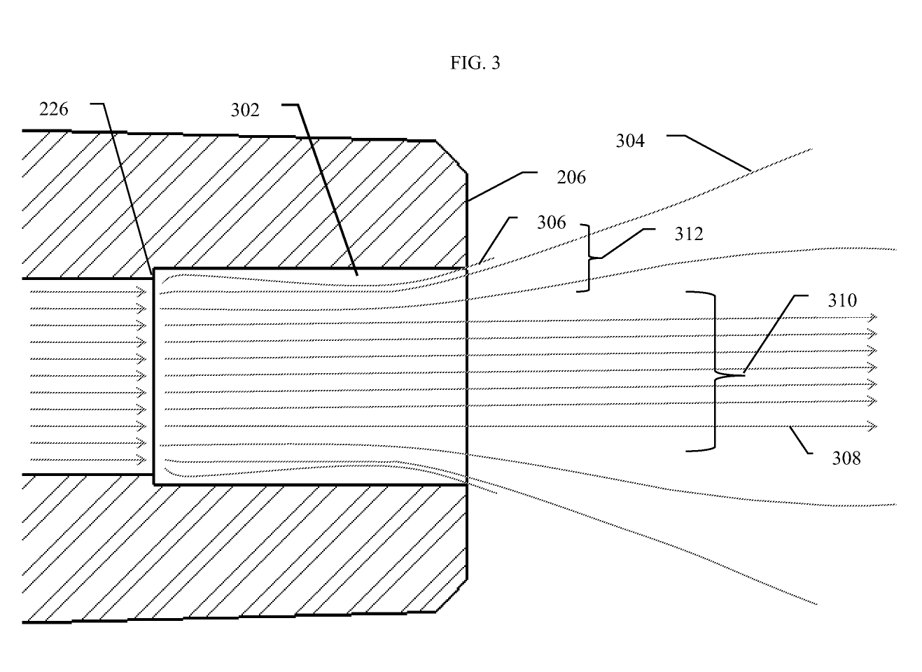

In an embodiment, the diameters and lengths of the inlet section 212, the flow section 214, and/or the expansion section 216 may vary depending on the particular application in which the nozzle 200 is used. In a wellbore servicing operation, the length 219 of the flow section 214 may be greater than about three times its diameter 220, alternatively greater than about four times its diameter 220. The diameter 220 of the flow section 214 may be measured as the minimum diameter of the flow section 214 when the diameter 220 varies over the length 219 of the flow section 214. The length 218 of the inlet section 212 may be less than about 2 times the diameter 220 of the flow section 214. The length 222 of the expansion section 216 may range from about one half of the diameter 220 of the flow section 214 to about four times the diameter 220 of the flow section 214 taking into account the need for the expanding fluid to contact the edge of the expansion section 216 prior to the outer edge 206 as described in more detail infra. In an embodiment, the diameter 224 of the expansion section 216 may be about 1.01 to about 1.5 times the diameter 220 of the flow section 214. In an embodiment, the overall length (i.e., the sum of lengths 218, 219, and 222) of the nozzle 200 may be about 0.5 inches to about 6 inches, alternatively about 0.75 to about 4 inches. The diameter of the flow section 214 may be about 0.05 inches to about 2 inches, alternatively about 0.2 inches to about 1 inch. Referring to FIGS. 2 and 3, the fluid flow through interior flowpath 204 expands into the expansion section 216 in a conical stream after passing through the flow section 214 over shoulder 226.

Without intending to be limited by theory, it is believed that the fluid stream formed by fluid passing through the nozzle 200 will generally form a conical stream following stream lines shown in FIG. 3, such as stream lines 304, 306, and 308. The fluid stream may naturally expand due to the interaction or friction between the fluid stream and the fluid inside the interior flowpath 204, which may slow down the outer skin of fluid in the fluid stream. This slowing may result in the slight expansion of the fluid stream. This natural expansion of the fluid may be used to design the interior flow path diameter 224, which may be selected so that the outer diameter of the outer skin 304 of the fluid stream is slightly smaller than the interior flow path diameter 224 when the stream leaves the tip section 206. The natural expansion of the fluid through the expansion section 216 varies between about 0.5 degrees and 3 degrees as measured at the edge of the flow section 214 in a direction parallel to the longitudinal axis of the interior flowpath 204. In an embodiment, the expansion section 216 diameter 224 and length 222 may be configured to ensure that the diameter 224 is slightly larger than the diameter of the fluid stream 304 at the outer end 206 of the nozzle. This way, the original outer fluid stream 304 may pull fluid by means of friction out of chamber 302 to create a new flow stream 306 originating from chamber 302. As a result, a region of pressure below the pressure present outside of outer end 206 may be created in chamber 302, The region of reduced pressure may pull fluid into it from resources such as the jet stream itself or the fluid upstream of outer edge 206 (e.g., within flow passage 142). In other words, if the length 222 and diameter 224 of the expansion section 216 are configured such that a diameter of a fluid stream discharged from the nozzle 200 (i.e. the diameter of the flow stream 306) is approximately equal to or slightly less than the diameter 224 of the expansion section 216 at the outer end 206 of the nozzle 200, then any backflow of fluid outside of the nozzle 200 into the expansion section 216 is prevented when fluid is flowing through the nozzle 200.

Since the flowrate of the fluid stream through the nozzle 200 is based on the pressure differential across the nozzle 200, the resulting decrease in pressure due to the expansion section 216 may result in a higher fluid flowrate through the nozzle 200. Alternatively, a decreased pressure may be used to generate an equivalent fluid flowrate through the nozzle 200 as compared to a nozzle without the expansion section 216 as described herein. While the chamber 302 results in a decreased pressure, it is not expected that any cavitation would occur within the chamber 302, and in an embodiment, no cavitation of the fluid occurs within the expansion section 216. In an embodiment, any combination of increased flowrate and/or decreased pressure may be achieved between these two limits.

In an embodiment, the use of the expansion section 216 as described herein may result in a pressure drop within the expansion section 216 of greater than about 10%, alternatively greater than about 20%, alternatively greater than about 30%, or alternatively greater than about 40% as compared to the pressure at the outer edge of a nozzle not having an expansion section 216. In an embodiment, the use of an expansion section 216 in the nozzle 200 and a constant fluid supply pressure may result in an increased flowrate of fluid through the nozzle 200 of greater than about 10%, alternatively greater than about 20%, alternatively greater than about 30%, or alternatively greater than about 40% as compared to a nozzle not comprising an expansion section 216. The corresponding decrease in pressure may allow smaller pumps and/or a reduced power input to the pumps to be used during a workover operation and/or a higher volume of fluid to be passed through the nozzles with the same pumping units.

The use of the expansion section 216 and the resulting chamber 302 may allow the coefficient of discharge of the nozzle 200 to be increased to greater than about 1.0. The coefficient of discharge relates the relative stream diameter of an exiting stream to the fluid stream within the nozzle along with the relative velocity profile of the stream at the location where the exiting diameter is measured. In general, a stream exiting a nozzle decreases in response to the pressure profile over the cross-section of the fluid stream, which generally has a higher velocity, and a corresponding lower pressure, at its core (e.g., section 310) as compared to its outer edges (e.g., section 312). In general, the Coefficient of Discharge (C_{d}) can be computed by the following relationship:

$${C}_{d} = \frac{Q}{A \sqrt{\frac{2 Δ P}{ρ}}} \qquad ( Eq . 1 )$$

where Q is flow rate, A is the area base upon the smallest inner diameter 220 of the jet, p is the fluid density, and ΔP is pressure differential across jet 200. In an embodiment, the use of the expansion section 216 may allow the nozzle 200 to achieve a coefficient of discharge of greater than 1.0, alternatively greater than about 1.1, alternatively greater than about 1.2, or alternatively greater than about 1.3.

Due to the decreased pressure differential across the nozzle 200, the resulting fluid stream exiting the nozzle 200 may expand in a wider cone than a comparable stream from a nozzle not comprising an expansion section 216. For example, the fluid velocity of the outer edge of the flowstream may have a decrease in velocity of about 5% to about 20% relative to a nozzle not comprising the expansion section 216. The core of the flow stream, however, may have the same velocity as a nozzle without the expansion section 216. In other words, for an equivalent pressure drop across the nozzles, the core velocity may increase 3% to 6% for the nozzle comprising the expansion section 216, thereby increasing cutting efficiency. This represents an equivalent energy conversion for a nozzle with an without the expansion section 216. While this may result in a more rapid drop-off in the velocity of the outer edge fluid, for an energy balance condition, it is believed that the velocity of the fluid core 310 may increase in order to maintain the energy balance, at least over a sufficient distance to ablate and/or penetrate the formation. Accordingly, an overall advantage can be realized in the form of an unexpected decrease in the pressure requirements and/or an increased fluid flowrate with only a decrease in the fluid velocity of a small portion of the fluid exiting the nozzle 200.

The nozzle may be operated by providing a fluid to the inner end 208 and allowing the fluid to flow through the interior flowpath 204 and exit the outer end 206. The fluid entering the nozzle 200 is at a higher pressure than the ambient pressure adjacent the outer edge 206 of the nozzle, thereby allowing the fluid to flow through the nozzle 200. Upon initiation of flow through the nozzle 200, the fluid may expand out of the flow section 214, past shoulder 226, and flow in a conical flow pattern into the expansion section 216. Due to the conical flow pattern touching the walls of the body 202 in the expansion section 216, fluid from outside of the nozzle 200 is prevented from flowing into the expansion section 216. A chamber 302 may then be formed with a pressure below that of the ambient pressure outside the outer edge 206 of the nozzle. The resulting fluid flow through the nozzle 200 may experience a decreased pressure drop and/or an increased flowrate through the nozzle 200. Further, the nozzle 200 may have a coefficient of discharge greater than 1.0.

In an embodiment, the nozzle 200 may be used in a service tool to service a wellbore 114. Generally, servicing a wellbore 114 may be carried out for a plurality of formation zones (as shown in FIG. 1) starting from a formation zone in the furthest or lowermost end of the wellbore 114 (i.e., toe) and sequentially backward toward the closest or uppermost end of the wellbore 114 (i.e., heel). Referring to FIG. 1, the wellbore servicing may begin by disposing a liner hanger comprising a float shoe and a float collar disposed near the toe, and a tubing section 126 comprising a plurality of service assemblies 148 comprising a nozzle 200 as described with respect to FIGS. 2 and 3. The service assembly 148 may be positioned adjacent the formation zone to be treated. While the orientation of the service assembly 148 is illustrated as being horizontal, in alternative methods of servicing a wellbore, the service assembly may be deviated, vertical, or angled, which can be selected based on the wellbore conditions. Prior to servicing of the wellbore, cementing of the wellbore may be performed via the float shoe and collar. In an embodiment, the service assembly 148 may initially be in a closed position wherein there is no fluid communication between the flow path 142 and the formation zone 12, and may be subsequently opened using any methods known to one of ordinary skill in the art with the aid of this disclosure. For example, the service assembly 148 may be actuated by hydraulically applying pressure, by mechanically, or electrically shifting a sleeve to move sleeve ports and the annular gap.

An abrasive wellbore servicing fluid (such as a fracturing fluid, a particle laden fluid, a cement slurry, etc.) may then be pumped down the wellbore 114 into the flow path 142 and through one or more nozzles 200. In an embodiment, the wellbore servicing fluid is an abrasive fluid comprising from about 0.5 to about 1.5 pounds of abrasives and/or proppants per gallon of the mixture (lbs/gal), alternatively from about 0.6 to about 1.4 lbs/gal, alternatively from about 0.7 to about 1.3 lbs/gal. As the abrasive wellbore servicing fluid is pumped down and passed through the interior flowpath 204 of the nozzle 200, a fluid jet is formed. Generally, the abrasive wellbore servicing fluid is pumped down at a sufficient flow rate and pressure to form a fluid jet through the nozzles 200 at a velocity of from about 50 to about 2700 feet per second (ft/s), alternatively about 300 to about 2000 ft/sec, alternatively from about 350 to about 1000 ft/sec, alternatively from about 400 to about 600 ft/sec for a period of from about 2 to about 10 minutes, alternatively from about 3 to about 9 minutes, alternatively from about 4 to about 8 minutes at a suitable original flow rate as needed by the service process. The pressure of the abrasive wellbore servicing fluid may be increased from about 2000 to about 5000 psig, alternatively from about 2500 to about 4500 psig, alternatively from about 3000 to about 4000 psig and the pumping down of the abrasive wellbore servicing fluid is continued at a constant pressure for a period of time. In an embodiment, the use of one or more nozzles 200 as described herein may reduce the pressure requirements by greater than about 10%, alternatively greater than about 20%, alternatively greater than about 30%, or alternatively greater than about 40%.

At the end of the jetting period, the fluid jets may have eroded the lining and/or formation zone to form slots and/or perforation tunnels (and optionally micro-fractures and/or extended fractures depending upon the treatment conditions and formation characteristics) within the lining and/or formation zone. If needed, the flow rate of the abrasive wellbore servicing fluid may be increased typically to less than about 4 to 5 times the original flow rate to form slots and/or perforation tunnels of a desirable size and/or geometry. The formation of slots and/or perforation tunnels may be desirable when compared to multiple fractures. Typically, slots and/or perforation tunnels lead to the formation of dominant/extended fractures, which provide less restriction to hydrocarbon flow than multiple fractures, and increase hydrocarbon production flow into the wellbore 114.

In an embodiment, the nozzle 200 and/or one or more additional components of the service tool may be removed. For example, the nozzle 200 and/or one more additional components may be removed by continued abrasion by flow of the abrasive wellbore servicing fluid and/or by degradation such as contacting the nozzle 200 and/or one or more additional components with an acid that degrades nozzle 200 and/or one or more additional components. The abrasive fluid and/or degradation fluid (e.g., acid) may be pumped down the flow path 142 for a sufficient time to completely (or partially) remove the nozzle 200 and/or one or more additional components. In alternative embodiments, the nozzle 200 and/or one or more additional components may be removed by any suitable method, for example, by mechanically removing the nozzle 200 and/or one or more additional components using coiled tubing or other devices or methods. Such actions may aid the wellbore service by increasing the area available for fluid flow through the tool and into the formation.

In an embodiment, the abrasive fluid may be displaced with another wellbore servicing fluid (for example, a proppant laden fracturing fluid that may or may not be similar to the abrasive wellbore servicing fluid) and the wellbore servicing fluid may be pumped through the nozzles 200 and/or additional apertures in the service assembly to form and extend dominant fractures in fluid communication with the slots and/or perforation tunnels. The dominant fractures may expand further and form micro-fractures in fluid communication with the dominant fractures. Generally, the dominant fractures expand and/or propagate from the slots and/or perforation tunnels within the formation zone to provide easier passage for production fluid (i.e., hydrocarbon) to the wellbore 114. Once the fractures are formed and extended, hydrocarbons can be produced by flowing the hydrocarbons from the micro-fractures (if present), to the dominant fractures, to the slots and/or perforation tunnels, and into the service assembly.

The number of intervals or zones, the order in which the service assemblies comprising the nozzles described herein are used (e.g., partially and/or fully opened and/or closed), the service assemblies, the wellbore servicing fluid, etc. shown herein may be used in any suitable number and/or combination and the configurations shown herein are not intended to be limiting and are shown only for example purposes. Any desired number of formation zones may be treated or produced in any order.

In another embodiment, the work string 1112 of FIG. 1B may be used to service a wellbore. In connection with formations in which the wellbores extend for relatively long distances, either vertically, horizontally, or angularly, the jet sub 1148, the valve sub 1152, and the workstring 1112 can be initially placed at the toe section (i.e., the farthest section from the ground surface) of the well. Treatment of the subterranean formation 1102 using one or more servicing fluids may be carried out in intervals and repeated numerous times throughout the wellbore section (e.g., such as every 100 to 200 feet).

Referring to FIG. 1B, the wellbore servicing may begin by disposing the work string 1112 comprising the valve sub 1152 and the jet sub 1148, which comprises a nozzle 200 as described with respect to FIGS. 2 and 3. The jet sub 1148 may be positioned adjacent the formation zone to be treated. While the orientation of the work string 1112 is illustrated as being horizontal, in alternative methods of servicing a wellbore, the work string 1112 may be deviated, vertical, or angled, which can be selected based on the wellbore conditions. In an embodiment, the valve sub 1152 may initially be in an open position so that fluid flow is directed out of the work string 1112 rather than through the nozzle 200. The valve sub 1152 may be subsequently closed using any methods known to one of ordinary skill in the art with the aid of this disclosure. For example, a ball or dart may be dropped into the work string 1112, pass through the jet sub 1148, and seat on a shoulder within the valve sub 1152. One or more servicing fluids may be pumped down the work string 1112 to form a jet through the nozzle 200 for treating the subterranean formation 1102. For example, the various fluids may comprise a preflush fluid, a servicing or stimulation fluid, an afterflush fluid, and/or a diversion fluid. In some embodiments, the servicing fluid may comprise a foamed fluid and/or the servicing fluid may be foamed through the introduction of gas through the work string 1112.

In some embodiments, an initial fluid comprising an abrasive material may be used to form one or more passages in the casing 1120 and/or the subterranean formation 1102 to allow the other fluids to reach the subterranean formation 1102. In an embodiment, the fluid may comprise an abrasive fluid comprising from about 0.5 to about 1.5 pounds of abrasives and/or proppants per gallon of the mixture (lbs/gal), alternatively from about 0.6 to about 1.4 lbs/gal, alternatively from about 0.7 to about 1.3 lbs/gal. As the abrasive wellbore servicing fluid is pumped down and passed through the jet sub 1148 and the nozzle 200, a fluid jet is formed. Generally, the abrasive wellbore servicing fluid is pumped down at a sufficient flow rate and pressure to form a fluid jet through the nozzles 200 at a velocity of from about 50 to about 2700 feet per second (ft/s), alternatively about 300 to about 2000 ft/sec, alternatively from about 350 to about 1000 ft/sec, alternatively from about 400 to about 600 ft/sec for a period of from about 2 to about 10 minutes, alternatively from about 3 to about 9 minutes, alternatively from about 4 to about 8 minutes at a suitable original flow rate as needed by the service process. The pressure of the abrasive wellbore servicing fluid may be increased from about 30 to 50,000 psig, alternatively from about 2000 to about 10,000 psig, alternatively from about 2500 to about 5000 psig, alternatively from about 3000 to about 4000 psig and the pumping down of the abrasive wellbore servicing fluid is continued at a constant pressure for a period of time. At the end of the jetting period, the fluid jets may have eroded one or more passages in the casing 1120.

In an embodiment, a preflush fluid may be pumped down the work string 1112 and/or the annulus at pressures between the pressure of the pores of the formation and the fracture pressure. The preflush fluid can be non-acidic, acidic, or both. The preflush fluid may pass through the jet sub 1148 to form a fluid jet directed at the subterranean formation 1102.

A stimulation fluid may then pumped through the work string 1112 at pressures between the pore pressure and the fracture pressure. In some embodiments, the stimulation fluid may be pumped through the work string 1112 and the nozzle 200 at pressures above the fracture pressure of the formation. The stimulation fluid may comprise a conventional acid that is used in squeezing or matrix acidizing, along with various additives that are well known in the art. Typical acids may include, but are not limited to, mineral or organic acids, such as hydrochloric acid, hydrofluoric acid, formic acid, or acetic acid, or a blend thereof. The stimulation fluid may react with the subterranean formation 1102 to cause fracturing and squeezing, in a conventional manner.

Generally, the servicing fluids may be pumped down the work string 1112 at a sufficient flow rate and pressure to form a fluid jet through the nozzle 200. For example, the stimulation fluid may be pumped through the work string 1112 and out of the nozzle 200 in the jet sub 1148 to form a jet with a velocity of from about 50 to about 2700 feet per second (ft/s), alternatively about 300 to about 2000 ft/sec, alternatively from about 350 to about 1000 ft/sec, alternatively from about 400 to about 600 ft/sec. The stimulation fluid may be pumped out of the nozzles for a period sufficient to treat the interval of interest. In an embodiment, a suitable treatment period may range from about 2 to about 20 minutes, alternatively from about 3 to about 15 minutes, alternatively from about 4 to about 8 minutes at a suitable original flow rate as needed by the service process.

An afterflush fluid may then pumped down the work string 1112 and/or annulus to sweep the stimulation fluid out of the wellbore. This afterflush fluid is generally non-acidic. After a predetermined pumping of the afterflush fluid, a diversion stage may be initiated to insure that the fluid is spread over a relative large surface area of the subterranean formation 1102. Once the desired treatment of an interval is accomplished, the above steps may be repeated in another interval. The work string 1112 may then be removed from the wellbore and fluid can be recovered from the well. The fluid may comprise both the servicing fluid and hydrocarbons from the subterranean formation 1102.

While the nozzle 200 has been described herein in the context of a subterranean formation and a well, the nozzle 200 may be used in a variety of industrial settings where a high velocity fluid stream is desired with a reduced pressure or pumping requirements. For example, nozzle 200 may be used in with an apparatus for industrial cleaning, such as the industrial cleaning of hydrocarbon production equipment.

### EXAMPLES

In order to illustrate the benefits of the nozzles as described herein, several comparative examples have been prepared. The nozzle of the present disclosure has been compared to a conventional jet nozzle (e.g., commercially available as jetting tools from a variety of vendors worldwide), and a HydraJet nozzle (e.g., commercially available from Halliburton Energy Service, Inc., of Houston, Tex.), which do not comprise expansion chambers as described herein. In order to aid in comparison between the different nozzles, the same dimensions are used for the jets in each example unless otherwise noted (i.e. the internal diameters are the same). The conventional jetting tools generally have a C_{d} of around 0.7 (based on published data). The Halliburton HydraJet nozzle has a C_{d} of approximately 0.95 based upon test data. The “Current Nozzle” has an expansion chamber as described herein, and a C_{d} of 1.3 was selected for discussion in this example.

Calculation of the flow rates was made using Eq. 1 as described in more detail above. First, the conventional nozzle example uses a pressure differential across the nozzle of 4500 pounds per square inch (psi). Based upon Eq.1, the flow rate is 2.0189 BPM. Using the Halliburton jet nozzle at the same pressure produces a flow rate of 2.7399 BPM. The Current nozzle has a flowrate of 3.7493 BPM at the same pressure differential. In order to pump at approximately the same flow rate as the Halliburton nozzle (i.e., 2.7399 BPM), the pressure requirement for the new jet would be 2403.1 psi. Further, to pump at the same horsepower level as the Halliburton jet nozzle case, then, using the Current nozzle, the pressure differential would be 3651 psi, thereby producing a flowrate of about 3.377 BPM. The results of the nozzle calculations are shown in Table 1.

TABLE 1
Nozzle Calculation Results

| | | Jet Nozzle | | Fluid | Flow Rate |
|---|---|---|---|---|---|
| | | Diameter | Pressure | Density | (Barrels/ |
| | C_{d} | (in.) | (psig) | (lb/gal) | minute) |
| Conventional Jet | 0.7 | 0.25 | 4500 | 8.9 | 2.0189 |
| Nozzle | | | | | |
| Halliburton Jet | 0.95 | 0.25 | 4500 | 8.9 | 2.7399 |
| Nozzle | | | | | |
| Current Nozzle | 1.3 | 0.25 | 4500 | 8.9 | 3.7493 |
| Current Nozzle | 1.3 | 0.25 | 2403.1 | 8.9 | 2.7399 |
| Current Nozzle | 0.25 | 1.3 | 3651 | 8.9 | 3.3773 |

The results of the calculations indicate that the use of the expansion section with the nozzle as described herein allows for the nozzle to have a coefficient of discharge of 1.3. The resulting flow rate increase represents about an 85.7% increase over the convention jet nozzle and a 36.8% increase of the Halliburton jet nozzle using approximately the same input pressure. Alternatively, the use of the nozzle as described herein resulted in a 46.6% decrease in the pressure required to pass the same volume of fluid through the nozzle as compared to the Halliburton jet nozzle with a coefficient of discharge of 0.95. Accordingly, the nozzle comprising the expansion section illustrates an improvement over comparable nozzles not comprising an expansion section.

At least one embodiment is disclosed and variations, combinations, and/or modifications of the embodiment(s) and/or features of the embodiment(s) made by a person having ordinary skill in the art are within the scope of the disclosure. Alternative embodiments that result from combining, integrating, and/or omitting features of the embodiment(s) are also within the scope of the disclosure. Where numerical ranges or limitations are expressly stated, such express ranges or limitations should be understood to include iterative ranges or limitations of like magnitude falling within the expressly stated ranges or limitations (e.g., from about 1 to about 10 includes, 2, 3, 4, etc.; greater than 0.10 includes 0.11, 0.12, 0.13, etc.). For example, whenever a numerical range with a lower limit, R₁, and an upper limit, Rᵤ, is disclosed, any number falling within the range is specifically disclosed. In particular, the following numbers within the range are specifically disclosed: R=R₁+k*(Rᵤ−R₁), wherein k is a variable ranging from 1 percent to 100 percent with a 1 percent increment, i.e., k is 1 percent, 2 percent, 3 percent, 4 percent, 5 percent, . . . 50 percent, 51 percent, 52 percent, . . . , 95 percent, 96 percent, 97 percent, 98 percent, 99 percent, or 100 percent. Moreover, any numerical range defined by two R numbers as defined in the above is also specifically disclosed. Use of the term “optionally” with respect to any element of a claim means that the element is required, or alternatively, the element is not required, both alternatives being within the scope of the claim. Use of broader terms such as comprises, includes, and having should be understood to provide support for narrower terms such as consisting of, consisting essentially of, and comprised substantially of. Accordingly, the scope of protection is not limited by the description set out above but is defined by the claims that follow, that scope including all equivalents of the subject matter of the claims. Each and every claim is incorporated as further disclosure into the specification and the claims are embodiment(s) of the present invention.

What is claimed is:

1. A jetting tool comprising:
a nozzle with a coefficient of discharge greater than 1.0.

2. The jetting tool of claim 1, wherein a length and a diameter of an expansion section of the nozzle are configured such that a fluid stream diameter of a fluid stream discharged from the nozzle is equal to the diameter of the expansion section at an outer end of the nozzle.

3. The jetting tool of claim 2, wherein the nozzle has a pressure drop within the expansion section of greater than about 10% as compared to the pressure at an outer edge of a comparative nozzle not having an expansion section.

4. The jetting tool of claim 2, wherein the nozzle has an increased flowrate of fluid through the nozzle of greater than about 10% as compared to a comparative nozzle not comprising an expansion section.

5. A jetting nozzle comprising:
a body; and
an interior flow path within the body, wherein the interior flow path comprises:
a flow section; and
an expansion section;
wherein the expansion section has a diameter 1.01 to 1.5 times greater than a diameter of the flow section, and wherein a length and diameter of the expansion section are configured to prevent a backflow of fluid into the expansion section when a fluid is flowing through the nozzle.

6. The jetting nozzle of claim 5, wherein the body is constructed of an abrasion resistant material, an erosion resistant material, or an abrasion and erosion resistant material.

7. The jetting nozzle of claim 5, wherein the interior flow path further comprises an inlet section.

8. The jetting nozzle of claim 5, wherein a length of the flow section is greater than about three times the diameter of the flow section.

9. The jetting nozzle of claim 5, wherein the length of the expansion section is between about one half of the diameter of the flow section and about four times the diameter of the flow section.

10. The jetting nozzle of claim 5, wherein the expansion section comprises a chamber between a fluid flowing through the jetting nozzle and the inner edge of the expansion section.

11. The jetting nozzle of claim 10, wherein the chamber has a reduced pressure relative to a pressure of an ambient fluid outside of the nozzle.

12. The jetting nozzle of claim 5, wherein the nozzle has a coefficient of discharge of greater than 1.0.

13. A method of jetting comprising:
providing a pressurized fluid to a nozzle; and
allowing the pressurized fluid to flow through the nozzle, wherein the nozzle has a coefficient of discharge of greater than 1.0.

14. The method of claim 13, wherein the nozzle is part of a service tool servicing a wellbore disposed in a subterranean formation.

15. The method of claim 14, wherein the pressurized fluid comprises an abrasive wellbore servicing fluid.

16. The method of claim 14, further comprising: forming a fluid jet at the outlet of the nozzle.

17. The method of claim 16, wherein the fluid jet has a velocity of from about 300 feet per second to about 2000 feet per second.

18. The method of claim 16, further comprising: forming a slot or a perforation tunnel in the subterranean formation with the fluid jet.

19. The method of claim 18, further comprising: introducing a second pressurized fluid into the subterranean formation at a pressure sufficient to form one or more fractures in fluid communication with the slot or the perforation tunnel.

20. The method of claim 19, further comprising: allowing one or more hydrocarbons to flow from the one or more fractures through the slot or the perforation tunnel and into the wellbore.

21. The method of claim 16, wherein the fluid jet has a velocity of from about 50 feet per second to about 2700 feet per second.
